(19) United States
(12) Patent Application Publication
(10) Pub. No.: US 2011/0169777 A1
(43) Pub. Date: Jul. 14, 2011

(54) IMAGE PROCESSING APPARATUS, IMAGE DISPLAY SYSTEM, AND IMAGE PROCESSING METHOD

(75) Inventor: Makoto OUCHI, Matsumoto-shi (JP)

(73) Assignee: SEIKO EPSON CORPORATION, Tokyo (JP)

(21) Appl. No.: 12/985,486

(22) Filed: Jan. 6, 2011

(30) Foreign Application Priority Data
Jan. 12, 2010 (JP) 2010-004172

(51) Int. Cl. G06F 3/042

(52) U.S. Cl. 345/175

(57) ABSTRACT

An image processing apparatus includes: an under-detection object detecting section that detects an under-detection object area in an image displayed on a display screen based on image data, the detection being performed based on a captured image obtained by using a camera to capture the displayed image blocked by the under-detection object; and an application processor that extracts an under-detection object captured image contained in the under-detection object area, acquires shape data representing an image of the under-detection object from a database that stores the shape data and information data representing information on the under-detection object, checks the under-detection object captured image against the shape data, acquires the information data related to the shape data that matches the under-detection object captured image from the database, and outputs the information data.

### BACKGROUND

1. Technical Field

The present invention relates to an image processing apparatus, an image display system, and an image processing method.

2. Related Art

Projectors have been known as an image display apparatus. Projectors are characterized, for example, in that they are readily installed and can display a large-screen image. In recent years, projectors are used in a variety of applications and incorporated in a variety of image display systems.

For example, JP-A-2005-033756 proposes a technology for projecting an image bearing notes or other information through a projector on a target viewable by a local user. In JP-A-2005-033756, a video camcorder for capturing an image of the target is provided in a local position where the target is disposed, and a remote user in a remote position instructs the projector to display a note based on the image captured by the video camcorder.

The technology described in JP-A-2005-033756 allows a note to be projected on the target so that the local user can obtain information on the target.

In JP-A-2005-033756, however, since it is left to the remote user to determine whether or not a note is projected on the target and whether or not contents of the note are appropriate, the local user could not obtain desired information or the remote user could make enormous efforts in some cases.

Japanese Patent No. 3834766, United States Patent Application Publication No. 2009/0115721, JP-A-2008-152622, and JP-A-2009-64110 are exemplified as other related art documents.

### SUMMARY

An advantage of some aspects of the invention is to provide an image processing apparatus and an image processing method that allow an under-detection object, such as a target, to be precisely detected and information that matches the under-detection object to be automatically outputted. Another advantage of some aspects of the invention is to provide an image display system capable of automatically displaying an image that matches the under-detection object.

An image processing apparatus according to an aspect of the invention is an image processing apparatus that detects an under-detection object disposed between a display screen and a camera and outputs information on the under-detection object having been detected, the image processing apparatus including an under-detection object detecting section that detects an under-detection object area, which is a portion blocked by the under-detection object, in an image displayed on the display screen based on image data, the detection being performed based on a captured image obtained by using the camera to capture the displayed image blocked by the under-detection object, and an application processor that extracts an under-detection object captured image contained in the under-detection object area from the captured image, acquires shape data representing an image of the under-detection object from a database that stores the shape data and information data representing information on the under-detection object that corresponds to the shape data, the information data being related to the shape data, checks the under-detection object captured image against the shape data, acquires the information data related to the shape data that matches the under-detection object captured image from the database, and outputs the information data.

As described above, since the application processor acquires shape data representing an image of the under-detection object and checks the under-detection object captured image against the shape data, it is possible to judge whether or not the image represented by the shape data coincides with the under-detection object captured image. Based on the judgment, the application processor acquires and outputs information data related to the shape data that matches the under-detection object captured image, whereby information that matches the under-detection object is automatically outputted.

The image processing apparatus according to the aspect of the invention can have the following representative forms.

The image processing apparatus may further include an estimated captured image generating section that generates an estimated captured image from the image data based on image capturing information obtained by capturing a model image displayed on the display screen with the camera without being blocked by the under-detection object, and the under-detection object detecting section may detect the under-detection object area, which is a portion blocked by the under-detection object, in the displayed image based on the difference between the captured image and the estimated captured image.

As described above, since an estimated captured image is produced from the image data based on the image capturing information obtained when the model image is captured, and the difference between the estimated captured image and the captured image obtained by capturing the image displayed based on the image data is used to detect the under-detection object area, which is a portion blocked by the under-detection object, it is unnecessary to provide a dedicated camera, and the under-detection object area can be detected at a low cost. Further, since the difference between the estimated captured image and the captured image is used to detect the under-detection object area, it is possible to eliminate the influence of noise resulting from unevenness of external light, the state of the display screen, such as “corrugation,” “streaks,” and dirt, the position and distortion of the camera, and other factors. As a result, the under-detection object area can be precisely detected without being affected by the noise described above, and the shape of the under-detection object can be accurately determined.

The model image may be formed of multiple types of gray image, and the estimated captured image generating section may use multiple types of captured gray image obtained by using the camera to capture the multiple types of gray image displayed on the display screen to generate the estimated captured image having estimated pixel values of the pixels of the displayed image corresponding to the image data.

As described above, since multiple types of gray image are used as the model image, and captured gray images obtained by capturing the gray images are used to generate the estimated captured image, the number of, the capacity for, and other factors related to captured images referred to when an estimated captured image is produced can be greatly reduced in addition to the advantageous effect described above.

The image processing apparatus may further include an image region extracting section that extracts the displayed image region from the captured image and allows the shape of the displayed image in the captured image to coincide with the shape of the estimated captured image, and the under-detection object detecting section detects the under-detection object area based on a result of comparison for each pixel between the displayed image extracted by the image region extracting section and the estimated captured image.

As described above, since the displayed image is extracted from the captured image, and the under-detection object area is detected after the shape of the displayed image is allowed to coincide with the shape of the estimated captured image, the under-detection object area can be detected in a simple interpixel comparison process in addition to the advantageous effect described above.

The estimated captured image generating section may allow the shape of the estimated captured image to coincide with the shape of the displayed image in the captured image, and the under-detection object detecting section may detect the under-detection object area based on a result of comparison for each pixel between the displayed image in the captured image and the estimated captured image.

As described above, since the under-detection object area is detected after the shape of the estimated captured image is allowed to coincide with the shape of the displayed image in the captured image, no error due to noise resulting from shape correction of the estimated captured image is produced, whereby the under-detection object area can be detected more precisely.

A predetermined image for initialization displayed on the display screen may be captured by the camera, and the shape of the estimated captured image or the displayed image may be allowed to coincide with the shape of the other based on the positions of four corners of the image for initialization in the captured image.

As described above, since the shape of the estimated captured image or the displayed image is allowed to coincide with the shape of the other with reference to the positions of four corners of the image for initialization in the captured image, the detection of the under-detection object area can be more simplified in addition to the advantageous effect described above.

An image projection apparatus may be provided as an image display apparatus, and the displayed image maybe an image projected by the image projection apparatus based on the image data.

In this way, the region where the under-detection object is placed, for example, the upper surface of a desk, can be used as the display screen, whereby an image display system can be readily installed. Further part or all of an image bearing information on the under-detection object can be projected on the surface thereof, whereby a portion of the under-detection object can be readily related to displayed information.

The application processor may rotate one of the under-detection object captured image and an image represented by the shape data by a predetermined angle after the size of the under-detection object area is allowed to coincide with the size of the under-detection object represented by the shape data to determine a check value representing the correlation between the under-detection object captured image and the image represented by the shape data, repeat the check value determination process multiple times with a different rotation angle, and compare a check value showing the highest correlation in the multiple check value determination processes with a predetermined threshold to judge whether or not the under-detection object captured image coincides with the image represented by the shape data.

As described above, since the checking is performed after the size of the under-detection object area is allowed to coincide with the size of the under-detection object represented by the shape data, misjudgment due to difference in size can be eliminated. Further, since the check value representing the correlation between the under-detection object captured image and the image represented by the shape data is determined after the under-detection object captured image or the image represented by the shape data is rotated by a predetermined rotation angle, and the judgment is made by comparing a check value showing the highest correlation with a predetermined threshold, it is possible to reduce the occurrence of misjudgment due to the difference in posture of the under-detection object placed on the display screen. Further, since the posture of the under-detection object relative to the display screen is detected, it is possible to display an image bearing information in a position according to the portion of the under-detection object that corresponds to the information.

An image display system according to another aspect of the invention is an image display system including the image processing apparatus according to the above aspect of the invention, the camera that captures an image displayed on the display screen, and an image display apparatus that displays not only an image based on image data on the model image or the displayed image but also an image bearing the information data outputted from the image processing apparatus.

As described above, since information data representing information on an under-detection object is automatically outputted from the image processing apparatus, and the image display apparatus displays an image bearing the information data, information that matches the under-detection object is automatically displayed.

An image processing method of still another aspect of the invention is an image processing method for detecting an under-detection object disposed between a display screen and a camera and outputting information on the under-detection object having been detected, the image processing method including an image display step of displaying an image on the display screen based on image data, a displayed image capturing step of capturing the image displayed on the display screen in the image display step by using the camera with the displayed image being blocked by the under-detection object, an under-detection object detecting step of detecting an under-detection object area, which is a portion blocked by the under-detection object, in the displayed image based on the image captured in the displayed image capturing step, and an application processing step of extracting an under-detection object captured image contained in the under-detection object area from the captured image, acquiring shape data representing an image of the under-detection object from a database that stores the shape data and information data representing information on the under-detection object that corresponds to the shape data, the information data being related to the shape data, checking the under-detection object captured image against the shape data, acquiring the information data related to the shape data that matches the under-detection object captured image from the database, and outputting the information data.

As described above, since shape data representing an image of an under-detection object is acquired, an under-detection object captured image is checked against the shape data, and information data related to the shape data that matches the under-detection object captured image is acquired and outputted, information that matches the under-detection object is automatically outputted.

### BRIEF DESCRIPTION OF THE DRAWINGS

The invention will be described with reference to the accompanying drawings, wherein like numbers refer to like elements.

FIG. 1 is a diagram showing an example of the configuration of an image display system in a first embodiment.

FIG. 2 is a block diagram showing an example of the configuration of an image processing apparatus.

FIG. 3 is a block diagram showing an example of the configuration of an image processor.

FIG. 4 is a flowchart showing an example of how the image processing apparatus operates.

FIG. 5 is a flowchart showing calibration in step S10.

FIG. 6 describes the calibration in step S10.

FIG. 7 is a flowchart showing image region extraction initialization in step S20.

FIG. 8 describes the image region extraction initialization in step S20.

FIG. 9 is a flowchart showing image region extraction in step S28.

FIG. 10 describes the image region extraction in step S28.

FIG. 11 is a flowchart showing under-detection object area extraction in step S12.

FIG. 12 is a flowchart of estimated captured image generation in step S60.

FIG. 13 describes the estimated captured image generation in step S60.

FIG. 14 describes how the image processor in the first embodiment operates.

FIG. 15 is a flowchart showing an application process in step S14.

FIG. 16 is a conceptual diagram showing a data structure in a database.

FIG. 17 is a block diagram showing an example of the configuration of an image processor in a second embodiment.

FIG. 18 is a flowchart showing calibration in the second embodiment.

FIG. 19 is a flowchart showing under-detection object extraction in the second embodiment.

FIG. 20 describes how an estimated captured image is generated in the under-detection object extraction.

FIG. 21 describes how the image processor in the second embodiment operates.

FIG. 22 is a diagram showing an example of the configuration of an image display system in a third embodiment.

### DESCRIPTION OF EXEMPLARY EMBODIMENTS

Embodiments of the invention will be described below with reference to the drawings. In the drawings used in the description, the dimensions and scales of structures in the drawings may differ from those of corresponding actual structures in some cases in order to render characteristic portions readily recognizable. The same components in the embodiments have the same reference characters and no detailed description of these components may be made in some cases.

### First Embodiment

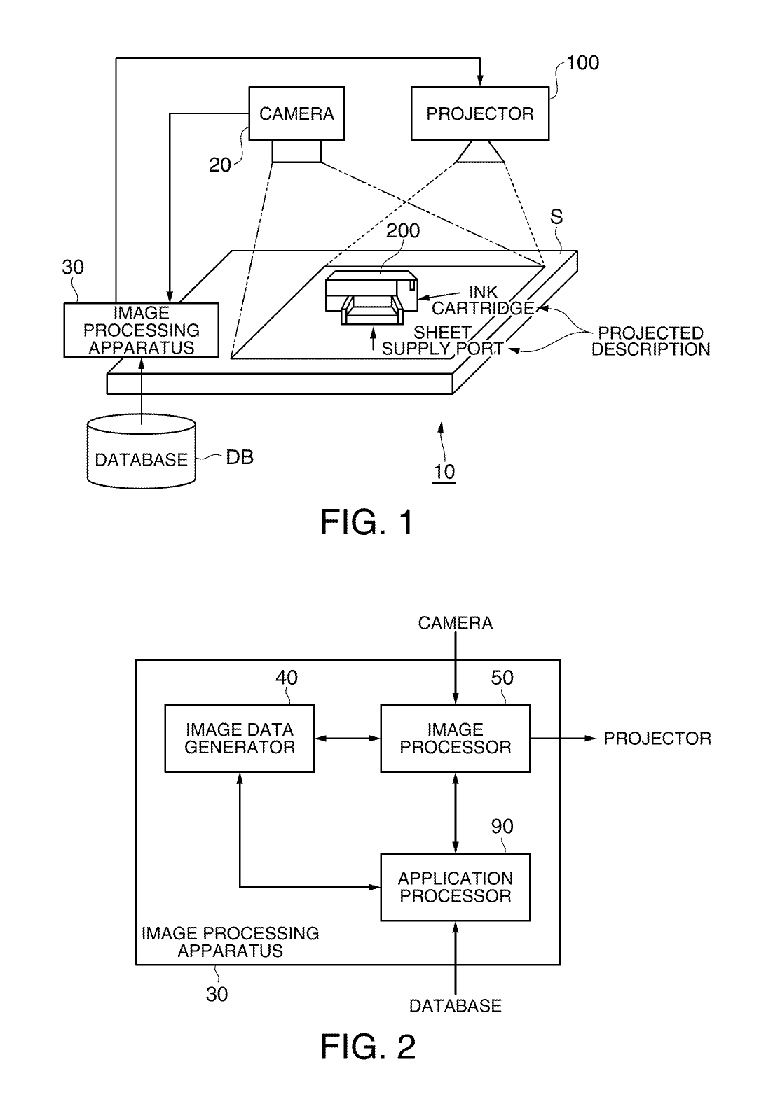

FIG. 1 is a diagram showing an example of the configuration of an image display system 10 in a first embodiment.

The image display system 10 includes a camera 20, an image processing apparatus 30, and a projector (image projection apparatus) 100 as an image display apparatus. The image processing apparatus 30 has a function of generating image data and supplies the generated image data to the projector 100. The projector 100 includes a light source, modulates the light from the light source based on the image data, and projects the modulated light on a projection surface S. An image formed by the projected light is thus displayed. Specifically, the projector 100 includes, for example, light valves each of which is formed of a transmissive liquid crystal panel as a light modulator, modulates the light from the light source in the light valves based on the image data for respective color components, combines the modulated light fluxes, and projects the combined light through a projection system or any other optical system on the projection surface S. The camera 20 is disposed in the vicinity of the projector 100. The camera 20 is so installed that the imageable range thereof includes the region of the projection surface S that is occupied by the image projected by the projector 100.

The image display system 10 is, for example, used as follows: The projection surface S in the image display system 10 is a desk or any other suitable surface on which an under-detection object 200 can be placed. The under-detection object 200 is a printer, a projector, an AED (Automated External Defibrillator), or any other portable object. The under-detection object 200 is a printer in the following description for ease of description. When a user places the under-detection object 200 on the projection surface S within a range where the projector 100 can project an image, the image display system 10 detects the under-detection object 200 and displays information that matches the under-detection object 200.

For example, when a printer is placed as the under-detection object 200 on the upper surface of a desk, information on the printer, such as the model and the status thereof, is displayed. When the thus placed printer, for example, has a tray-shaped sheet supply port and the port is open, a description of the sheet supply port and other information is displayed in a position corresponding to the sheet supply port.

An image bearing a description is projected from the projector 100 in a position related to an object under description. Part or all of the description may be superimposed and displayed on the object under description or maybe displayed with an arrow or any other symbol representing the relationship with the object under description in a position spaced apart therefrom. The image bearing the description may be a still image or video images. For example, a description of a portion that accommodates an ink cartridge may be displayed first, and then how to exchange the ink cartridge may be shown by displaying an actual ink cartridge exchange procedure in video images.

Alternatively, a portable image display system can be configured to deal with an under-detection object (an immobile object, for example) disposed in an arbitrary position. For example, a program capable of performing the function of the image processing apparatus 30 is installed in a notebook computer or any other portable personal digital assistant. The image processing apparatus 30 is then set to be communicable with a portable projector and camera in a wired or wireless manner. As a possible method for using the system described above, when a user aims the projector and the camera at an under-detection object, such as an automobile, a description of the automobile is displayed. Still alternatively, an image display system can, for example, be configured by incorporating a program that functions as the image processing apparatus in a mobile phone or any other similar apparatus with a camera and a projector incorporated therein. In the system, the communication function of the mobile phone can be used to send and receive data on an under-detection object to and from an external database.

A description will next be made of a mechanism that allows the image display system 10 to automatically display information on the under-detection object 200.

When the under-detection object 200 is present between the projector 100 and the projection surface S, part of the image displayed by the projector 100 is blocked. Being present between the projection surface S and the camera 20, the under-detection object 200 blocks an image projected on the projection surface S from being captured by the camera 20. When the under-detection object 200 thus blocks the projected image, the image processing apparatus 30 uses image capturing information obtained when the camera 20 captures the projected image to detect an under-detection object area blocked by the under-detection object 200 in the displayed image.

Specifically, the image processing apparatus 30 uses the image data corresponding to the image projected on the projection surface S to produce an estimated captured image, which is an estimated state produced if the camera 20 captures the projected image. The image processing apparatus 30 detects the under-detection object area based on the difference between a captured image obtained by using the camera 20 to capture the projected image blocked by the under-detection object 200 and the estimated captured image. The image processing apparatus 30 further extracts a captured image of the under-detection object 200 in the under-detection object area (under-detection object captured image) from the captured image obtained by using the camera 20 to capture the projected image blocked by the under-detection object 200.

The image processing apparatus 30 acquires shape data representing an image of the under-detection object 200 and checks the under-detection object captured image against the shape data. The image processing apparatus 30 acquires information data related to the shape data that matches the under-detection object captured image from a database. The information data is supplied as image data to the projector 100, which then displays an image bearing a description or other information based on the image data.

The function of the image processing apparatus 30 described above is achieved by a personal computer or dedicated hardware. The function of the camera 20 is achieved by a visible-light camera. It is therefore unnecessary to provide a dedicated camera, and the under-detection object area, which is the portion blocked by the under-detection object 200, can be detected at a low cost. Further, being detected based on the difference between an estimated captured image and a captured image, an under-detection object area can be precisely detected without being affected by noise resulting from external light, the state of the projection surface S, and other factors even when an image projected by the projector 100 on the projection surface S suffers from color unevenness due to the noise. It is therefore possible to extract an under-detection object captured image with precision and check the under-detection object captured image against shape data. Therefore, information data that matches the under-detection object can be acquired, and information that matches the under-detection object can be displayed automatically.

The image processing apparatus 30 will now be described in detail. FIG. 2 is a block diagram showing an example of the configuration of the image processing apparatus 30. The image processing apparatus 30 includes an image data generator 40, an image processor 50, and an application processor 90. The image data generator 40 generates image data corresponding to an image to be projected by the projector 100. The image processor 50 uses the image data generated by the image data generator 40 to detect an under-detection object area. The image processor 50 receives image capturing information obtained when the camera 20 captures an image projected on the projection surface S. The image processor 50 produces an estimated captured image from the image data based on the image capturing information from the camera 20 in advance and compares a captured image obtained by capturing the image projected on the projection surface S but blocked by the under-detection object 200 with the estimated captured image to detect the under-detection object area.

The application processor 90 extracts the image of the under-detection object area from the captured image obtained by capturing the image projected on the projection surface S but blocked by the under-detection object 200 to produce an under-detection object captured image, which is an image containing the captured under-detection object 200. The application processor 90 acquires shape data representing an image of the under-detection object 200 from the database and checks the under-detection object captured image against the shape data. The application processor 90 acquires information data related to the shape data that matches the under-detection object captured image from the database. The application processor 90 outputs the information data to the image processor 50. The image processor 50 generates image data based on the information data outputted from the application processor 90 and outputs the image data to the projector 100.

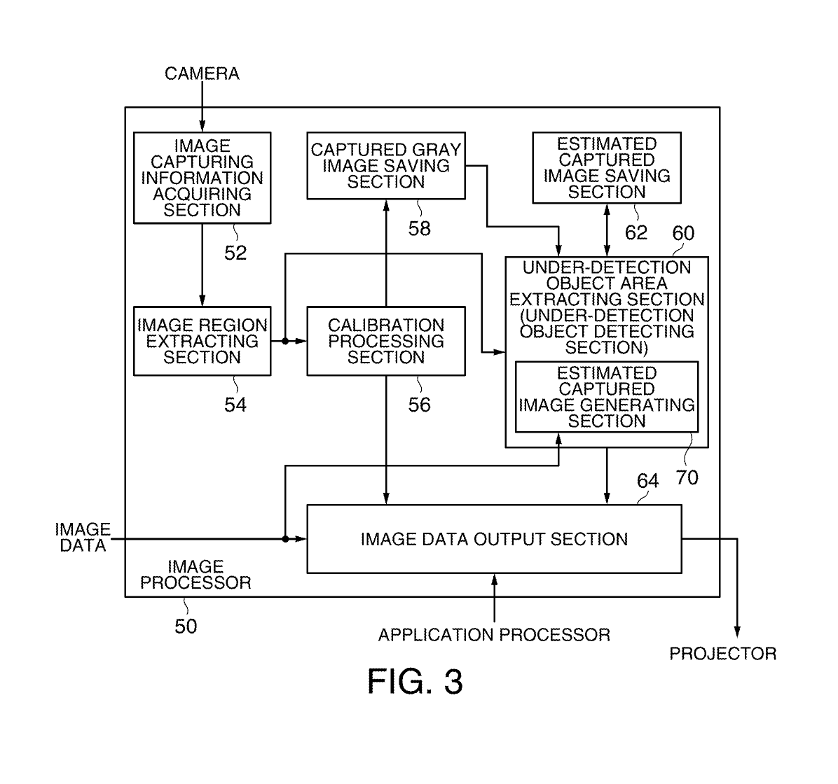

FIG. 3 is a block diagram showing an example of the configuration of the image processor 50. The image processor 50 includes an image capturing information acquiring section 52, an image region extracting section 54, a calibration processing section 56, a captured gray image saving section 58, an under-detection object area extracting section (under-detection object detecting section) 60, an estimated captured image saving section 62, and an image data output section 64. The under-detection object area extracting section 60 of the present embodiment includes an estimated captured image generating section 70.

The image capturing information acquiring section 52 acquires image capturing information corresponding to an image captured by the camera 20. The image capturing information acquiring section 52 may directly instruct the camera 20 to capture an image or may prompt the user to use the camera 20 to capture an image.

The image region extracting section 54 extracts a projected image in the captured image corresponding to the image capturing information acquired by the image capturing information acquiring section 52.

The calibration processing section 56 performs calibration before an estimated captured image is produced. In the calibration, the projector 100 displays a model image on the projection surface S, and the camera 20 captures the model image displayed on the projection surface S on which no under-detection object 200 is placed. An estimated captured image, which is an estimated image produced if the camera 20 captures the projected image, is produced by referring to the color and position of the model image that occupies the captured image.

In the first embodiment, multiple types of gray image are used as the model image. The multiple types of gray image have pixel values different from one another, but the pixel values are substantially the same in each of the gray images. With the multiple types of gray image displayed, the calibration processing section 56 acquires multiple types of captured gray image.

The captured gray image saving section 58 saves the captured gray images produced by the calibration processing section 56. An estimated captured image is produced by referring to the pixel values of the captured gray images.

Based on the difference between a captured image obtained by using the camera 20 to capture the image projected by the projector 100 but blocked by the under-detection object 200 and the estimated captured image produced from the captured gray images saved in the captured gray image saving section 58, the under-detection object area extracting section 60 extracts an under-detection object area, which is the portion blocked by the under-detection object 200 in the captured image. The captured image is an image obtained by capturing the image projected by the projector 100 on the projection surface S based on the image data referred to when the estimated captured image is produced. The estimated captured image generating section 70 estimates the color and other parameters of each pixel of the captured image from the camera 20 by producing an estimated captured image from the image data on the image projected by the projector 100 on the projection surface S by referring to the captured gray images saved in the captured gray image saving section 58. The estimated captured image produced by the estimated captured image generating section 70 is saved in the estimated captured image saving section 62.

The image data output section 64 outputs the image data from the image data generator 40 to the projector 100 in response to an instruction from the image processor 50 or the application processor 90.

As described above, the image processor 50 produces an estimated captured image from the image data on an image projected by the projector 100, the estimated captured image being an estimated image produced if the camera 20 captures the projected image. An under-detection object area is then extracted based on the difference between the estimated captured image and a captured image obtained by capturing the projected image displayed based on the image data. In this way, the difference between the estimated captured image and the captured image obtained by using the camera 20 used when the estimated captured image is produced can eliminate any influence of noise resulting from unevenness of external light, the state of the projection surface S, such as “corrugation,” “streaks,” and dirt, the position and the zooming status of the projector 100, the position and distortion of the camera 20, and other factors. As a result, the under-detection object area can be precisely detected without being affected by the noise described above. An example of how the image processing apparatus 30 operates will be described below.

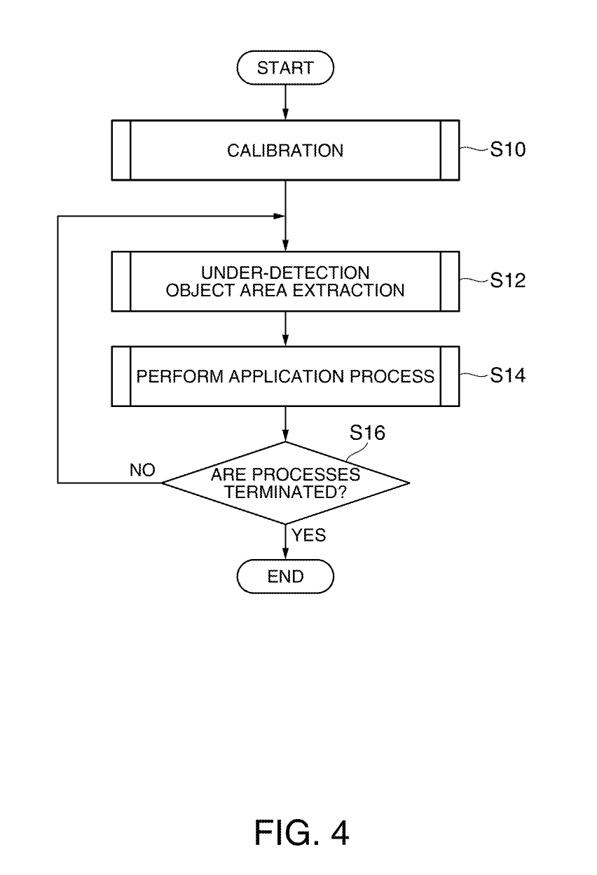

FIG. 4 is a flowchart showing an example of how the image processing apparatus 30 operates. First, the image processor 50 performs calibration in step S10. In the calibration, preparation for producing an estimated captured image is made by performing initialization required to produce the captured gray images described above and then producing multiple types of captured gray image.

In the following step S12, the image processor 50 extracts an under-detection object area contained in an image obtained by capturing a projected image blocked by the under-detection object 200. In the extracting process, the multiple types of captured gray image produced in step S10 are used to produce an estimated captured image. Based on the difference between the captured image obtained by using the camera 20 to capture the image projected by the projector 100 but blocked by the under-detection object 200 and the estimated captured image produced from the captured gray images saved in the captured gray image saving section 58, the region of the captured image that is blocked by the under-detection object 200 is extracted.

In the following step S14, the application processor 90 performs an application process based on the under-detection object area extracted in step S12. The application process is a process according to the result of detecting the under-detection object area, for example, a process of changing the projected image by changing the image data produced by the image data generator 40 based on the area of the under-detection object 200 extracted in step S12.

In the following step S16, the application processor 90 accepts an input from the user and judges, for example, whether or not the processes are terminated. When the judgment result is YES (Y in step S16), the series of processes are terminated. When the processes are not terminated (N in step S16), the control returns to step S12, and the processes in steps S12 to S16 are repeated.

### Example of Calibration

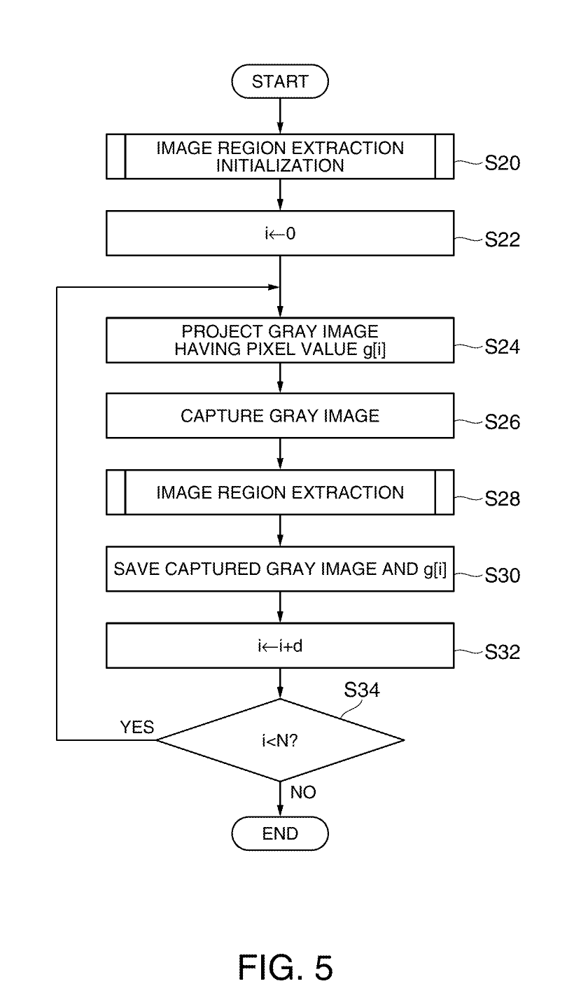

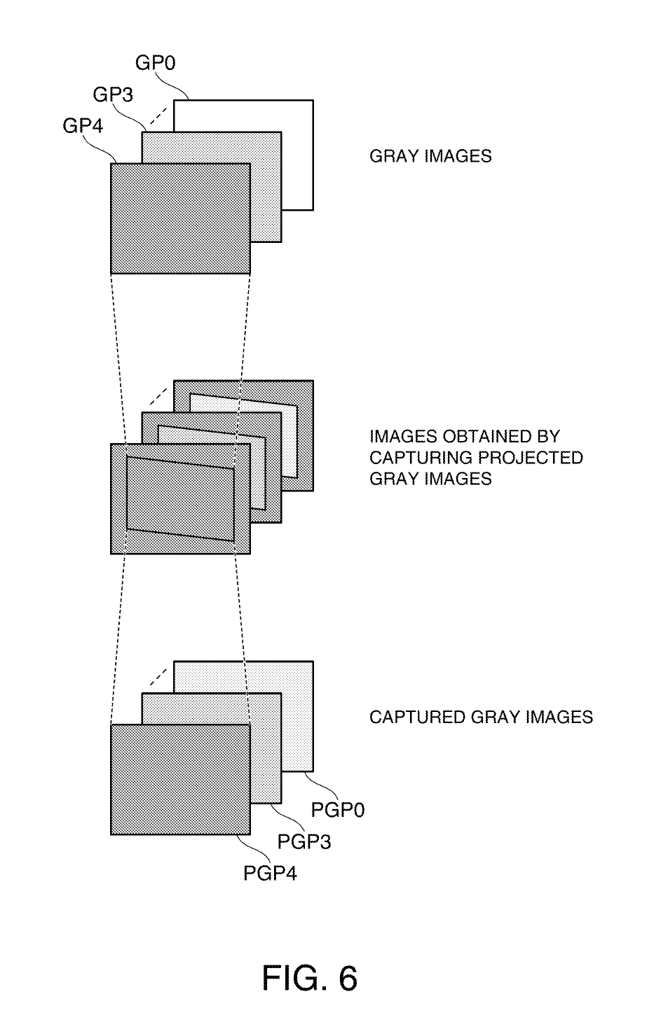

FIG. 5 is a flowchart showing an example of the calibration in step S10, and FIG. 6 describes how the calibration in step S10 is actually performed.

When the calibration starts, the image processing apparatus 30 performs in step S20 image region extraction initialization in the calibration processing section 56. In the image region extraction initialization, the image projected by the projector 100 is extracted from the image captured by the camera 20 after the region of the captured image that is occupied by the projected image is identified. Specifically, in the image region extraction initialization, the positions of the four corners of the projected image, which has a rectangular shape, in the captured image are extracted.

In the following step S22, the calibration processing section 56 initializes a variable i corresponding to the pixel value of a gray image, for example, by substituting zero into the variable i.

In the following step S24, the calibration processing section 56 projects a gray image having a pixel value g[i] on the projection surface S. For example, the calibration processing section 56 instructs the image data generator 40 to generate image data on the gray image having a pixel value g[i]. The image data output section 64 outputs the image data to the projector 100, which then projects the gray image having a pixel value g[i] on the projection surface S.

In the following step S26, the calibration processing section 56 instructs the camera 20 to capture the gray image having a pixel value g[i] and projected in step S24 and acquires image capturing information on the captured image from the image capturing information acquiring section 52.

In the following step S28, the image region extracting section 54 extracts the region of the gray image that occupies the captured image acquired in step s26. In the step S28, the region of the gray image is extracted based on the positions of the four corners obtained in step S20.

In the following step S30, the region of the gray image that has been extracted in step S28 is related to g[i] and saved as a captured gray image in the captured gray image saving section 58.

In the following step S32, the calibration processing section 56 adds an integer d to the variable i to update the variable i.

In the following step S34, the variable i updated in step S32 is compared with a predetermined maximum N, and it is determined whether the processes are repeated or terminated. When the updated variable i is greater than or equal to the maximum N (N in step S34), the series of processes are terminated (END). On the other hand, when the updated variable i is smaller than the maximum N (Y in step S34), the control returns to step S24, and the processes in steps S24 to S32 are repeated.

In the calibration, multiple types of captured gray image PGP0 to PGP4 are produced, as shown in FIG. 6. It is noted that a single pixel is formed of R, G, and B components and the pixel value of each of the color components is expressed by 8-bit image data. In a gray image GP0, for example, the pixel value of each of the color components is zero for all the pixels. In an analogous fashion, the pixel value of a gray image GP1 is 64, and the pixel value of a gray image GP4 is 255. The captured image PGP0 is obtained by capturing the gray image GP0, and the captured gray images PGP1 to PGP4 are similarly obtained by capturing the gray images GP1 to GP4. The captured gray images are referred to when an estimated captured image is produced, and the thus produced estimated captured image has image data representing the image actually projected by the projector 100 and reflecting the environment in which the projector 100 is used and the state of the projection surface S. Using gray images allows the number of, the capacity required for, and other factors related to captured images referred to when an estimated captured image is produced can be greatly reduced.

### Example of Image Region Extraction Initialization

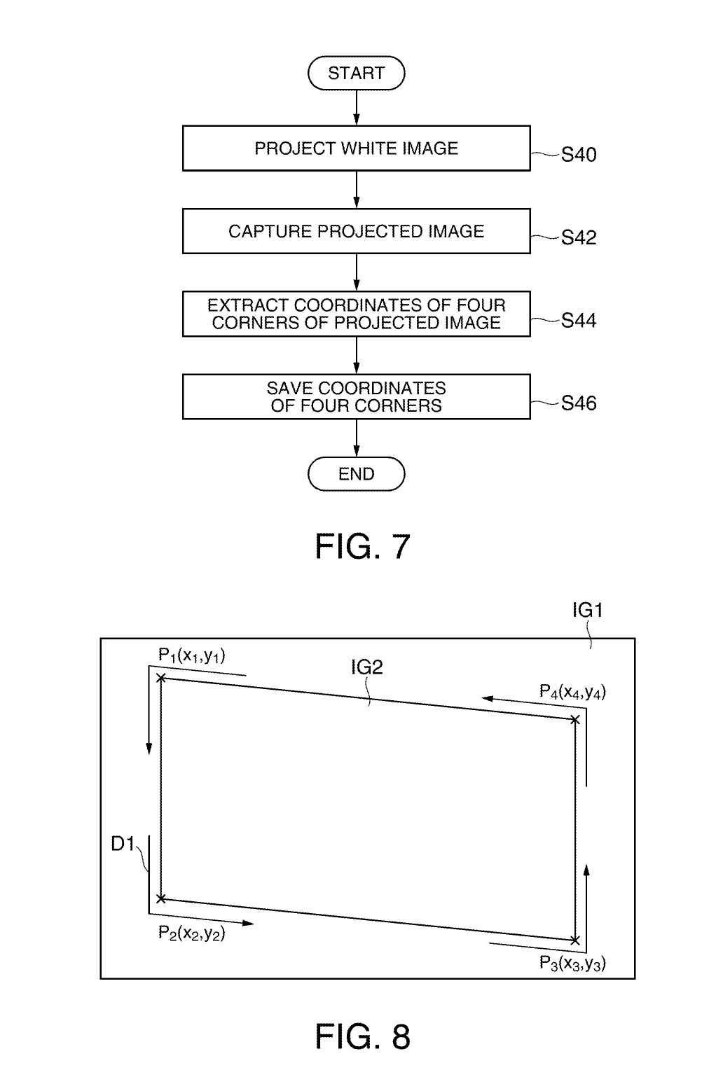

FIG. 7 is a flowchart showing an example of the image region extraction initialization in step S20, and FIG. 8 describes the image region extraction initialization in step S20. FIG. 8 diagrammatically shows an example of a projection surface IG1 that is part of the projection surface S and corresponds to the area captured by the camera 20 and an example of the area of a projected image IG2 on the projection surface IG1.

The calibration processing section 56, for example, instructs the image data generator 40 to generate image data on a white image all the pixels of which are white. In step S40, the image data output section 64 outputs the image data on the white image to the projector 100, which then projects the white image on the projection surface S.

In the following step S42, the calibration processing section 56 instructs the camera 20 to capture the white image projected in step S40. The image capturing information acquiring section 52 acquires image capturing information on the captured white image.

In the following step S44, the image region extracting section 54 extracts coordinates P₁ (x₁, y₁), P₂ (x₂, y₂), P₃ (x₃, y₃), and P₄ (x₄, y₄) of the four corners of the white image in the captured image. In this process, for example, the image region extracting section 54 detects a circumferential direction D1 while detecting the outer circumference of the projected image IG2 and extracts a point where the change in the angle of the circumferential direction D1 is greater than or equal to a threshold as the coordinates of a corner.

In the following step S46, the image region extracting section 54 saves the coordinates P₁ (x₁, y₁), P₂ (x₂, y₂), P₃ (x₃, y₃), and P₄ (x₄, y₄) of the four corners extracted in step S44 as information for identifying the region of the captured image that occupies the projected image and then terminates the series of processes (END).

The case where a white image is projected has been described in FIG. 7, but the invention is not limited thereto. The region of a captured image that occupies a projected image can be precisely extracted by setting the projected image in such a way that the region of projected image that occupies the captured image greatly differs from the other region in terms of grayscale.

### Example of Image Region Extraction

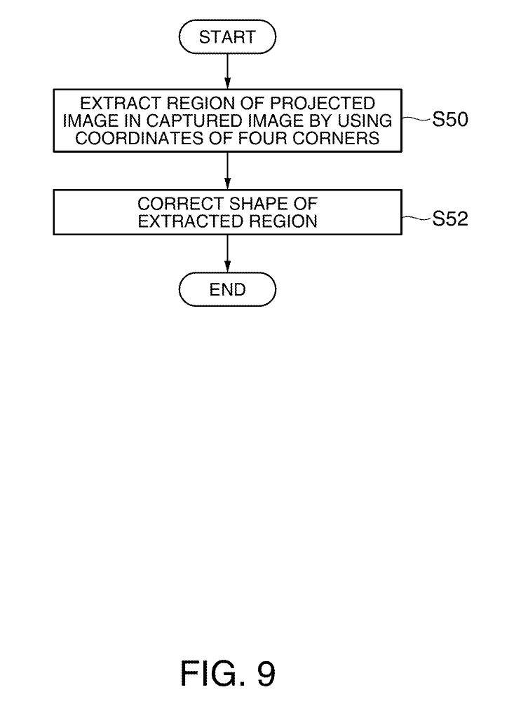

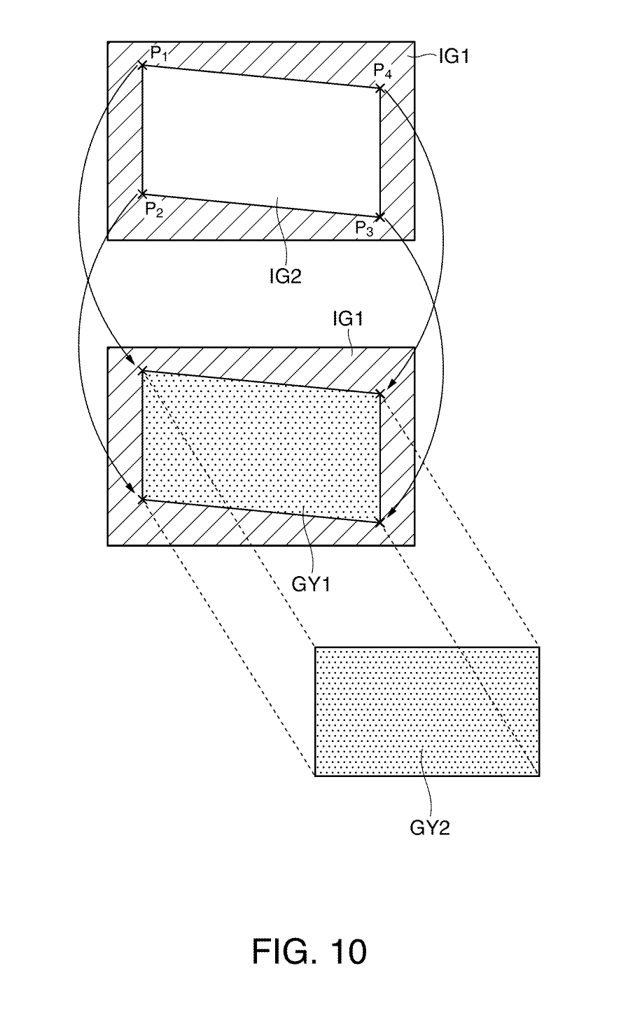

FIG. 9 is a flowchart showing an example of the image region extraction in step S28, and FIG. 10 describes the image region extraction in step S28. FIG. 10 diagrammatically shows how to extract the region of the projected image IG2 projected on the projection surface IG1, which is part of the projection surface S and corresponds to the area captured by the camera 20.

In step S50, the image region extracting section 54 extracts the region of a captured gray image that occupies the captured image obtained in step S26 from the captured image based on the coordinates of the four corners of the projected image extracted in step S44. For example, the image region extracting section 54 uses the coordinates P₁ (x₁, y₁), P₂ (x₂, y₂), P₃ (x₃, y₃), and P₄ (x₄, y₄) of the four corners of the projected image to extract a captured gray image GY1, as shown in FIG. 10.

In the following step S52, the image region extracting section 54 corrects the shape of the captured gray image GY1 extracted in step S50 to a rectangular shape and terminates the series of processes (END). The step S50 allows a rectangular captured gray image GY2 to be produced, for example, from the captured gray image GY1 and the shape of the captured gray image GY2 to coincide with the shape of an estimated captured image.

### Example of Under-Detection Object Area Extraction

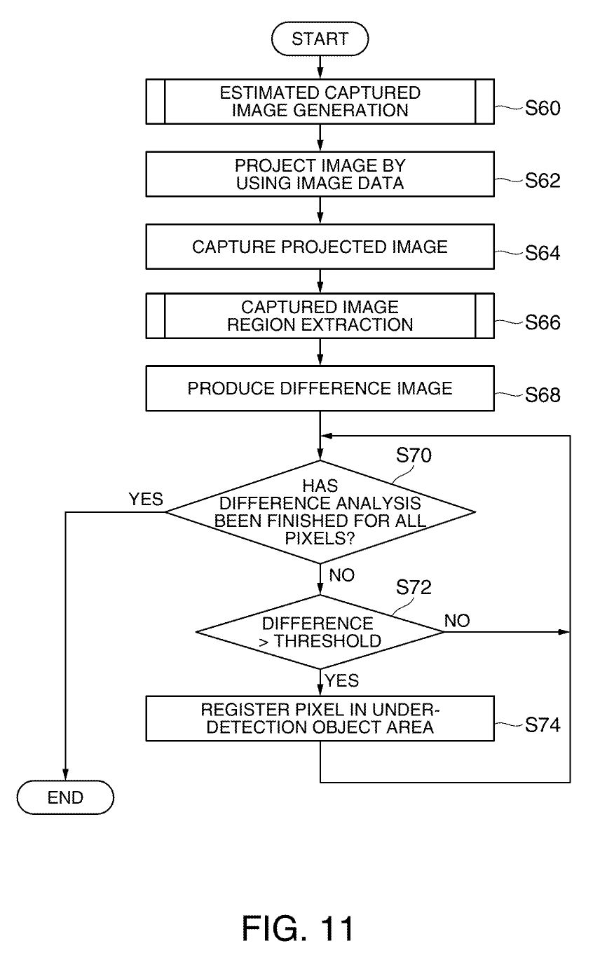

FIG. 11 is a flowchart showing an example of the under-detection object area extraction in step S12.

When the under-detection object area extraction starts, the under-detection object area extracting section 60 instructs the estimated captured image generating section 70 to perform estimated captured image generation in step S60. In the estimated captured image generation, the estimated captured image generating section 70 refers to each pixel value of the captured gray images saved in step S30 and converts the original image data to generate image data on an estimated captured image. The under-detection object area extracting section 60 saves the image data on the estimated captured image generated in step S60 in the estimated captured image saving section 62.

In the following step S62, the image data output section 64 outputs the original image data used to generate the image data on the estimated captured image to the projector 100 in response to an instruction from the under-detection object area extracting section 60. The projector 100 projects an image on the projection surface S based on the original image data.

In the following step S64, the under-detection object area extracting section 60 instructs the camera 20 to capture the image projected in step S62 with the under-detection object 200 placed on the projection surface S. The under-detection object area extracting section 60 then acquires image capturing information on the captured image via the image capturing information acquiring section 52. Part of the image projected by the projector 100 is blocked by the under-detection object 200, and the captured image acquired in the step S64 contains an under-detection object area, which is the region of the projected image that is blocked by the under-detection object.

In the following step S66, the under-detection object area extracting section 60 extracts the region of the captured image obtained in step S64 that is occupied by the image projected in step S62. In the process in step S66, the region of the projected image that occupies the captured image obtained in step S64 is extracted based on the coordinates of the four corners extracted in step S44, as in the image region extraction described above.

In the following step S68, the under-detection object area extracting section 60 compares the estimated captured image saved in the estimated captured image saving section 62 with the projected image extracted from the captured image in step S66 to calculate for each pixel the difference between the corresponding pixel values. A difference image is thus produced.

In the following steps S70 to S74, the under-detection object area extracting section 60 analyzes the difference for each pixel of the difference image. When the difference analysis is finished for all the pixels of the difference image (Y in step S70), the under-detection object area extracting section 60 terminates the series of processes (END). When the difference analysis is not finished for all the pixels (N in step S70), the under-detection object area extracting section 60 judges whether or not the difference is greater than a threshold in step S72.

When it is judged in step S72 that the difference is greater than the threshold (Y in step S72), the under-detection object area extracting section 60 registers in step S74 the pixel under judgment as a pixel in the under-detection object area, which is the portion blocked by the under-detection object 200, and the control returns to step S70. When it is judged in step S72 that the difference is not greater than the threshold (N in step S72), the control returns to step S70 and the under-detection object area extracting section 60 changes the pixel under judgment to the next one and continues the relevant processes.

### Example of Estimated Captured Image Generation

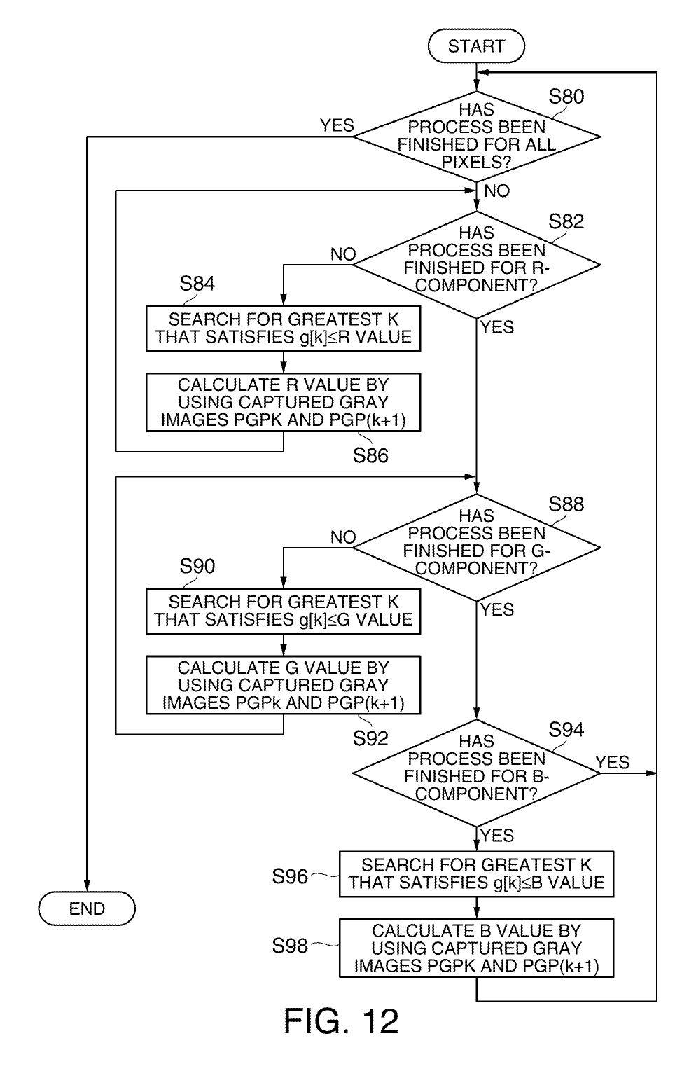

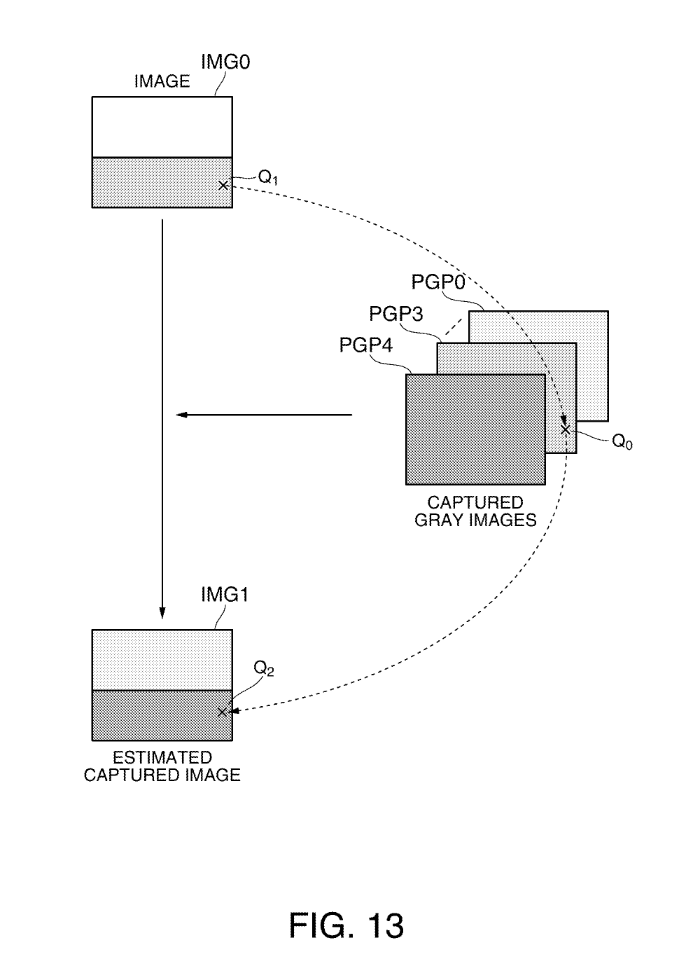

FIG. 12 is a flowchart showing an example of the estimated captured image generation in step S60, and FIG. 13 describes how the estimated captured image generation in step S60 is actually carried out. FIG. 13 diagrammatically shows the estimated captured image generation for a single color component among a plurality of color components that form a single pixel.

The estimated captured image generating section 70 generates an estimated captured image by referring to the captured gray images on a color component basis for all the pixels of the image corresponding to the image data outputted to the projector 100. First, when the process is not finished for all the pixels (N in step S80), the estimated captured image generating section 70 determines whether or not the process is finished for all the R-component pixels (step S82).

In step S82, when the process is not finished for all the R-component pixels (N in step S82), the estimated captured image generating section 70 searches for the greatest k (k is an integer) that produces g[k] smaller than or equal to the R value (R-component pixel value) (step S84). When the process is finished for all the R-component pixels in step S82 (Y in step S82), the control proceeds to step S88, and an estimated captured image is produced for the G component, which is the next color component.

Subsequent to step S84, the estimated captured image generating section 70 performs interpolation using the R-component pixel value in the position of the pixel in a captured gray image PGPk that corresponds to the k that the estimated captured image generating section 70 searched for in step S84 and the R-component pixel value in the position of that pixel in a captured gray image PGP(k+1) to determine the R value (step S86). When the captured gray image saving section 58 stores no captured gray image PGP(k+1), k can be used as the R value to be determined.

The estimated captured image generating section 70 next judges whether or not the process is finished for all the G-component pixels (step S88). When the process is not finished for all the G-component pixels in step S88 (N in step S88), the estimated captured image generating section 70 searches for the greatest k (k is an integer) that produces g[k] smaller than or equal to the G value (G-component pixel value) (step S90). When the process is finished for all the G-component pixels in step S88 (Y in step S88), the control proceeds to step S94, and an estimated captured image is produced for the B component, which is the next color component.

Subsequent to step S90, the estimated captured image generating section 70 performs interpolation using the G-component pixel value in the position of the pixel in the captured gray image PGPk that corresponds to the k that the estimated captured image generating section 70 searched for in step S90 and the G-component pixel value in the position of that pixel in the captured gray image PGP(k+1) to determine the G value (step S92). When the captured gray image saving section 58 stores no captured gray image PGP(k+1), k can be used as the G value to be determined.

The estimated captured image generating section 70 judges whether or not the process is finished for all the B-component pixels (step S94). When the process is not finished for all the B-component pixels in step S94 (N in step S94), the estimated captured image generating section 70 searches for the greatest k (k is an integer) that produces g[k] smaller than or equal to the B value (B-component pixel value) (step S96). When the process is finished for all the B-component pixels in step S94 (Y in step S94), the control returns to step S80.

Subsequent to step S96, the estimated captured image generating section 70 performs interpolation using the B-component pixel value in the position of the pixel in the captured gray image PGPk that corresponds to the k that the estimated captured image generating section 70 searched for in step S96 and the B-component pixel value in the position of that pixel in the captured gray image PGP(k+1) to determine the B value (step S98). When the captured gray image saving section 58 stores no captured gray image PGP(k+1), k can be used as the B value to be determined. The control then proceeds to step S80, and the estimated captured image generating section 70 continues the processes described above.

The estimated captured image generating section 70 determines, by carrying out the processes described above when an image IMG0 represented by the image data is used, for each pixel thereof, a captured gray image PGPk whose pixel value (R, G, or B value) is close to that in a pixel position Q₁, as shown in FIG. 13. The estimated captured image generating section 70 then uses the pixel value in a pixel position Q₀ in the captured gray image that corresponds to the pixel position Q₁ to determine the pixel value in a pixel position Q₂ in an estimated captured image IMG1 that corresponds to the pixel position Q₁. In this process, the estimated captured image generating section 70 uses the pixel value in the pixel position Q₀ in the captured gray image PGPk or the pixel values in the pixel position Q₀ in the captured gray images PGPk and PGP(k+1) to determine the pixel value in the pixel position Q₂ in the estimated captured image IMG1. The estimated captured image generating section 70 repeats the processes described above on a color component basis for all the pixels to produce the estimated captured image IMG1. In the image processor 50, the under-detection object area, which is the portion blocked by the under-detection object 200, can be extracted by carrying out the processes described with reference to FIGS. 5 to 13 as follows.

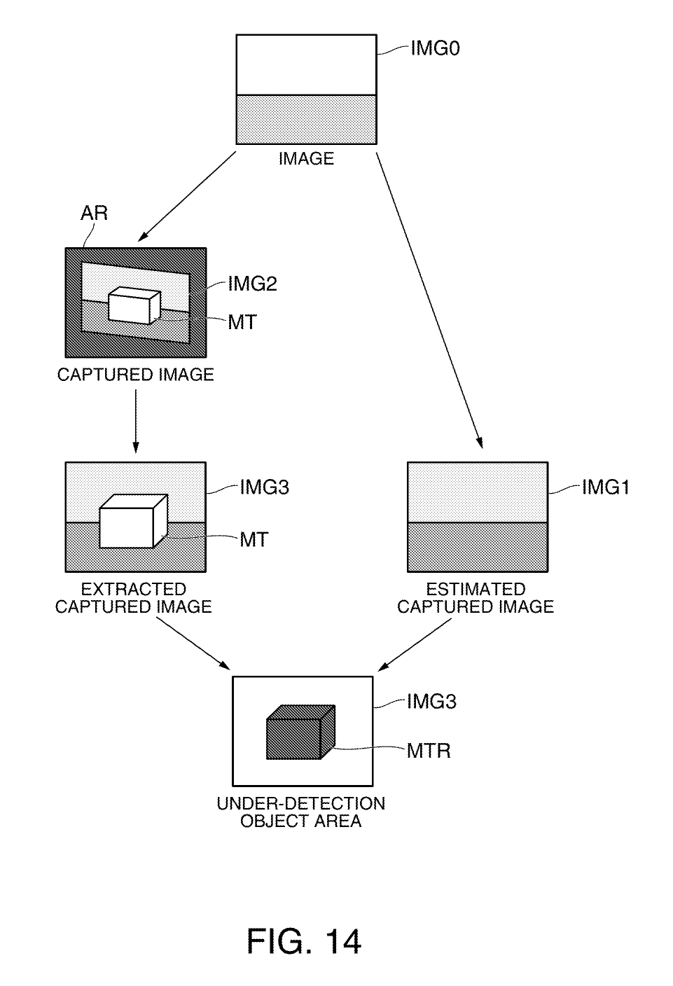

FIG. 14 describes how the image processor 50 operates. The image processor 50 uses the image data that forms the image IMG0 projected by the projector 100 to produce the estimated captured image IMG1. Further, the image processor 50 instructs the projector 100 to project an image (displayed image) IMG2 based on the image data in a projection area AR (projection surface IG1) of the projection surface S. The image processor 50 instructs the camera 20 to capture the image IMG2 in the projection area AR with the under-detection object 200 placed on the projection surface S and acquires the image capturing information on the thus captured image. The captured image contains a captured image MT formed of the captured under-detection object 200.

The image processor 50 extracts a projected mage IMG3 in the captured image based on the acquired image capturing information. The image processor 50 determines the difference between the projected image IMG3 in the captured image and the estimated captured image IMG1 for each pixel and extracts based on the difference an under-detection object area MTR, which is the area blocked by the under-detection object 200 in the projected image IMG3. The application processor 90 performs, for example, the following application process based on the extracted under-detection object area.

### Example of Application Process

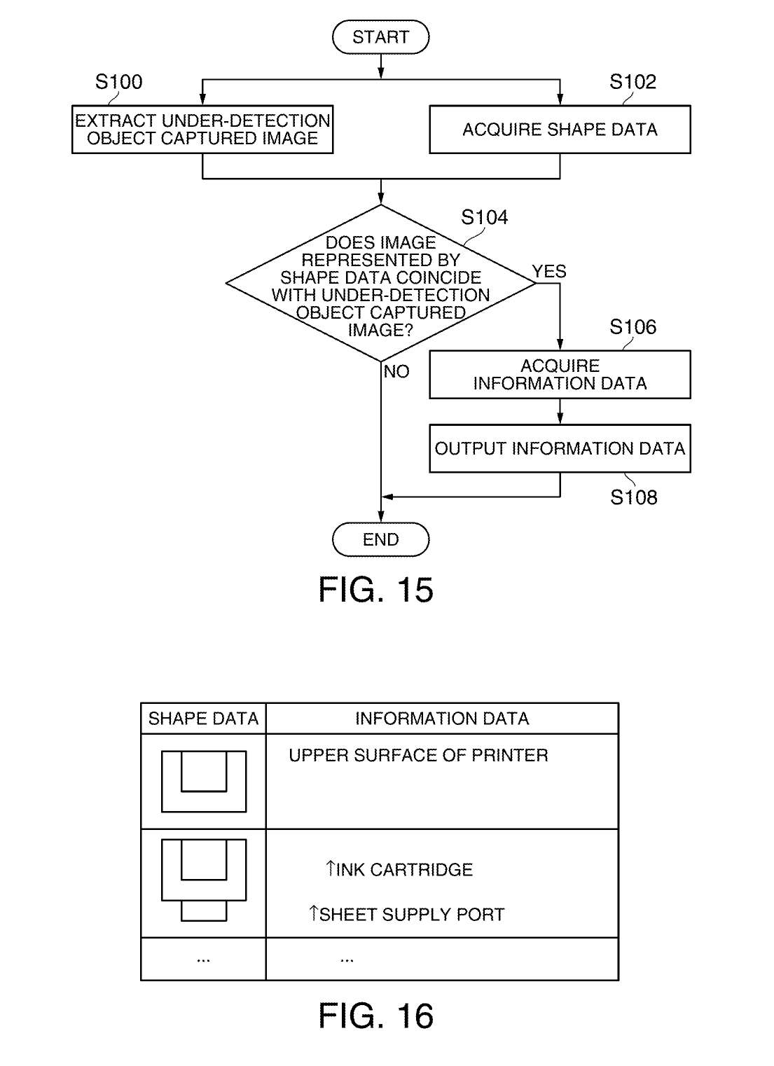

FIG. 15 is a flowchart showing an example of the application process in step S14, and FIG. 16 is a conceptual diagram showing the data structure in the database DB.

The application processor 90 performs an application process based on the under-detection object area extracted in the under-detection object area extraction in step S12. As shown in FIG. 15, the application processor 90 extracts the pixels corresponding to the pixels of the under-detection object area registered in step S74 from the captured image obtained by using the camera 20 to capture the image projected on the projection surface S but blocked by the under-detection object 200 and forms an under-detection object captured image by using the set of extracted pixels (step S100).

The application processor 90 acquires shape data registered in the database DB (step S102). The database DB may be provided as part of the image processing apparatus 30 or the image display system 10 or may be provided external to the image processing apparatus 30 or the image display system 10.

As shown in FIG. 16, the database DB stores the shape data representing images of the under-detection object, and each of the images is related to information data representing information on the under-detection object. For example, when the under-detection object is a printer, the database DB stores shape data representing an image of the printer viewed from the above, and the image is related to information data indicating that the image shows the upper surface of the printer. The database DB further stores data representing an image of the printer viewed from the above with the tray-shaped sheet supply port open, and the image is related to information data representing information on the positions of the sheet supply port and the ink cartridge.

The application processor 90 checks the image represented by the shape data acquired from the database DB against the under-detection object captured image extracted in step S100 and judges whether or not the image represented by the shape data coincides with the under-detection object captured image (step S104). In the present embodiment, a check value representing the correlation between the under-detection object captured image and the image represented by the shape data is calculated, and the check value is compared with a predetermined threshold to judge whether the under-detection object captured image coincides with the image represented by the shape data. To judge the coincidence, an appropriate judging method can be selected from a variety of judging methods.

In a first judging method, for example, the difference (absolute value) in pixel value between pixels in pixel positions that correspond to each other between two images is determined on a pixel basis, and the total of the difference values across the images is set to the check value. When the check value is smaller than or equal to a predetermined threshold, it is judged that the two images coincide with each other.

In a second judging method, for example, pattern checking using a plurality of pixels is carried out between two images based on image correlation or any other suitable technique, and a correlation coefficient used in the checking is set to the check value. When the correlation coefficient is greater than or equal to a predetermined threshold, it is judged that the two images coincide with each other.

The first judging method excels the second judging method in reduction in calculation burden required in the judgment. The second judging method excels the first judging method in that the coincidence can be precisely judged even when the positions of pixels that correspond to each other between two images are shifted from each other.

In the present embodiment, before the judgment of the coincidence, at least one of the image represented by the shape data and the under-detection object captured image is enlarged or reduced so that the size of the under-detection object in the image represented by the shape data coincides with the size of the under-detection object in the under-detection object captured image. In this way, when the size of the under-detection object in the image represented by the shape data and the size of the under-detection object in the under-detection object captured image differ from each other, it is possible to reduce the occurrence of misjudgment due to the shift in position of each point on an actual under-detection object between the two images. To make the size of the under-detection object in the image represented by the shape data equal to the size of the under-detection object in the under-detection object captured image, for example, the image represented by the shape data or the under-detection object captured image is so converted that the number of pixels that form the contour of the under-detection object in the image represented by the shape data coincide with that in the under-detection object captured image, or the number of pixels contained in the image represented by the shape data coincides with the number of pixels in the under-detection object captured image. Since the number of pixels that form the contour of the image represented by the shape data and the number of pixels contained therein are known in advance, the number of pixels that form the contour and the number of pixels contained in the image may be related to the shape data and then stored in the database.

Having undergone the size equalization, one of the image represented by the shape data and the under-detection object captured image is rotated by a predetermined angle, and the check value is determined by using the rotated image and the other non-rotated image, for example, in the first method. Determining the check value with a different rotation angle is repeated multiple times to determine multiple check values. It is then judged that the image represented by the shape data coincides with the under-detection object captured image when the check value showing the highest correlation among the multiple check values (minimum check value in this description) is smaller than or equal to a predetermined threshold. It is therefore possible to reduce the occurrence of misjudgment due to the difference in posture of the under-detection object 200 placed on the projection surface S. It is further possible to know the rotation angle by which the under-detection object captured image is so rotated that the rotated image coincides with the image represented by the shape data, whereby an image bearing information can be projected in a desired position relative to the under-detection object 200.

Alternatively, an estimated captured image by which a captured image of the under-detection object placed on the projection surface S is estimated may be produced based on the shape data, for example, in the same manner as in the estimated captured image generation described above, and then the thus produced estimated captured image and the under-detection object captured image may be checked against each other. It is therefore possible to reduce the occurrence of misjudgment due to external light incident on the under-detection object 200, the state of the camera 20 in use, or other factors.

When it is judged that the image represented by the shape data coincides with the under-detection object captured image (Y in step S104), the application processor 90 acquires information data related to the shape data from the database DB (step S106). The application processor 90 then outputs the acquired information data to the image data output section 64 in the image processor 50 (step S108) and terminates the series of processes (END). The image data output section 64 produces image data on an image bearing information contained in the information data and outputs the image data to the projector 100.

When it is judged that the image represented by the shape data does not coincide with the under-detection object captured image (N in step S104), the application processor 90 terminates the series of processes (END).

As a result of carrying out the processes described above, information data that matches the under-detection object 200 is automatically outputted from the image processing apparatus 30.

The image processing apparatus 30 may include a central processing unit (hereinafter referred to as a CPU), a read only memory (hereinafter referred to as a ROM), and a random access memory (hereinafter referred to as a RAM), and the CPU, after reading a program stored in the ROM or the RAM, may carry out software processes corresponding to the program to achieve the processes in the first embodiment described above. In this case, the program that allows the processes described above to be carried out is stored in the ROM or the RAM.

### Second Embodiment

In the first embodiment, a projected image is extracted from a captured image obtained by using the camera 20 to capture an image projected on the projection surface S, but the invention is not limited to the first embodiment. Alternatively, the area of the under-detection object 200 may be extracted without extraction of the projected image in the captured image. An image processing apparatus in a second embodiment differs from the image processing apparatus 30 in the first embodiment in terms of the configuration and actions of the image processor.

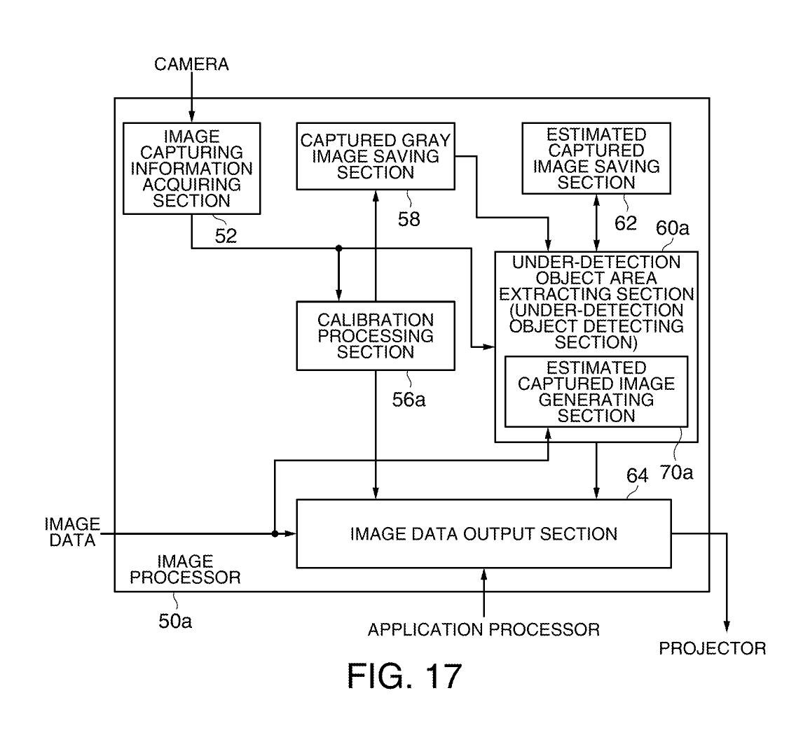

FIG. 17 is a block diagram showing an example of the configuration of the image processor in the second embodiment. An image processor 50a in the second embodiment includes an image capturing information acquiring section 52, a calibration processing section 56a, a captured gray image saving section 58, an under-detection object area extracting section (under-detection object detecting section) 60a, an estimated captured image saving section 62, and an image data output section 64. The under-detection object area extracting section 60a includes an estimated captured image generating section 70a. The image processor 50a differs from the image processor 50 in that the image region extracting section 54, which is present in the image processor 50, is omitted and that the under-detection object area extracting section 60a (estimated captured image generating section 70a) produces an estimated captured image having the shape of an image captured by the camera 20. To this end, image capturing information acquired by the image capturing information acquiring section 52 is supplied to the calibration processing section 56a and the under-detection object area extracting section 60a.

The calibration processing section 56a performs calibration as in the first embodiment and also acquires image capturing information from the image capturing information acquiring section 52, the image capturing information produced by the camera 20 when an estimated captured image is produced in the calibration process without being blocked by the under-detection object 200. That is, with multiple types of gray image displayed, the calibration processing section 56a acquires image capturing information on the multiple types of captured gray images from the image capturing information acquiring section 52. The captured gray image saving section 58 saves the captured gray images provided by the calibration processing section 56a. An estimated captured image, which is an estimated displayed image captured by the camera 20, will be produced by referring to the pixel value of any of the pixels of the captured gray images.

In the under-detection object area extracting section 60a, based on the difference between a captured image obtained by using the camera 20 to capture an image projected by the projector 100 but blocked by the under-detection object 200 and the estimated captured image produced from the captured gray images stored in the captured gray image saving section 58, the area of the under-detection object 200 in the captured image is extracted, as in the first embodiment. The captured image is an image corresponding to the image capturing information acquired by the image capturing information acquiring section 52. The estimated captured image generating section 70a generates the estimated captured image from the image data on the image projected by the projector 100 on the projection surface S by referring to the captured gray images stored in the captured gray image saving section 58. The estimated captured image generated by the estimated captured image generating section 70a is saved in the estimated captured image saving section 62.

The image processor 50a thus produces the estimated captured image, which is an estimated image actually captured by the camera 20, from the image data on the image projected by the projector 100. The area of the under-detection object 200 is then extracted based on the difference between the estimated captured image and the captured image obtained by capturing the projected image displayed based on the image data. In this way, the difference between the estimated captured image and the captured image obtained by using the camera 20 used when the estimated captured image is produced can be used to eliminate the influence of noise resulting from unevenness of external light, the state of the projection surface S, such as “corrugation,” “streaks,” and dirt, the position and the zooming state of the projector 100, the position and distortion of the camera 20, and other factors. As a result, the area of the under-detection object 200 can be precisely detected without being affected by the noise described above. In this process, since the area of the under-detection object 200 is extracted based on the difference image without any shape correction, no error due to noise resulting from shape correction is produced, whereby the area of the under-detection object 200 can be detected more precisely than in the first embodiment.

The image processing apparatus including the thus configured image processor 50a in the second embodiment can be used with the image display system 10 shown in FIG. 1. The actions of the image processing apparatus in the second embodiment are similar to those in the first embodiment, but the calibration in step S10 and the under-detection object area extraction in step S12 differ from those in the first embodiment.

### Example of Calibration

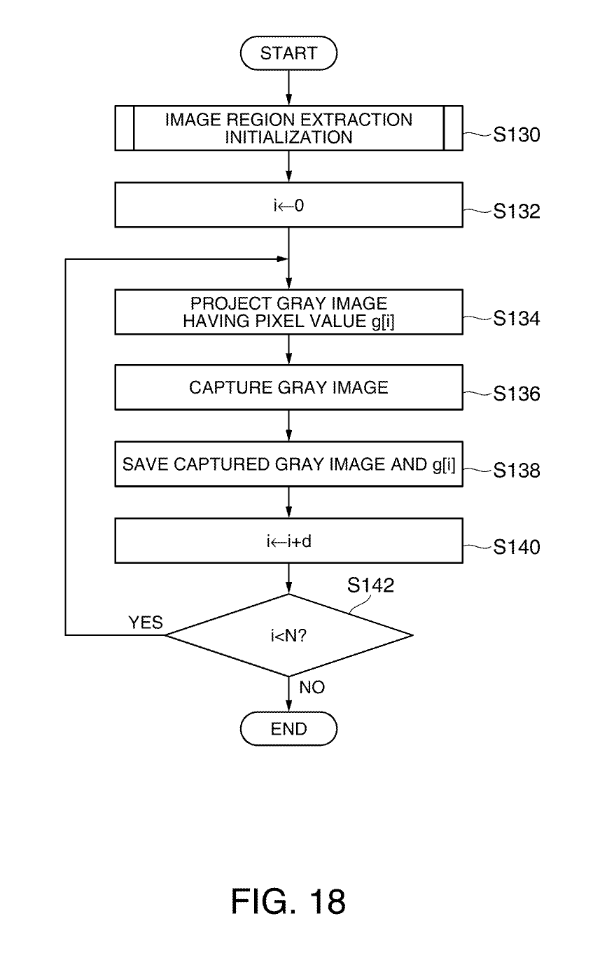

FIG. 18 is a flowchart showing an example of the calibration in the second embodiment. When the calibration starts, the calibration processing section 56a performs image region extraction initialization similar to that in the first embodiment (step S130). Specifically, in the image region extraction initialization, the coordinates of the four corners of a rectangular projected image in a captured image are extracted.

The calibration processing section 56a initializes a variable i corresponding to the pixel value of a gray image by setting it at “0” (step S132). The calibration processing section 56a subsequently instructs, for example, the image data generator 40 to generate image data on a gray image having a pixel value g[i] for each color component, and the image data output section 64 outputs the image data to the projector 100, which then projects the gray image having a pixel value g[i] on the projection surface S (step S134). The calibration processing section 56a then instructs the camera 20 to capture the image projected on the projection surface S in step S134 to acquire image capturing information on the image captured by the camera 20 from the image capturing information acquiring section 52 (step S136).

The calibration processing section 56a then relates the captured gray image acquired in step S136 to g[i] corresponding thereto and saves them in the captured gray image saving section 58 (step S138).

The calibration processing section 56a updates the variable i by adding an integer d thereto to prepare for the following gray image capturing operation. When the variable i updated in step S140 is greater than or equal to a predetermined maximum N (N in step S142), the series of processes are terminated (END), whereas when the updated variable i is smaller than the maximum N (Y in step S142), the control returns to step S134.

### Example of Under-Detection Object Area Extraction

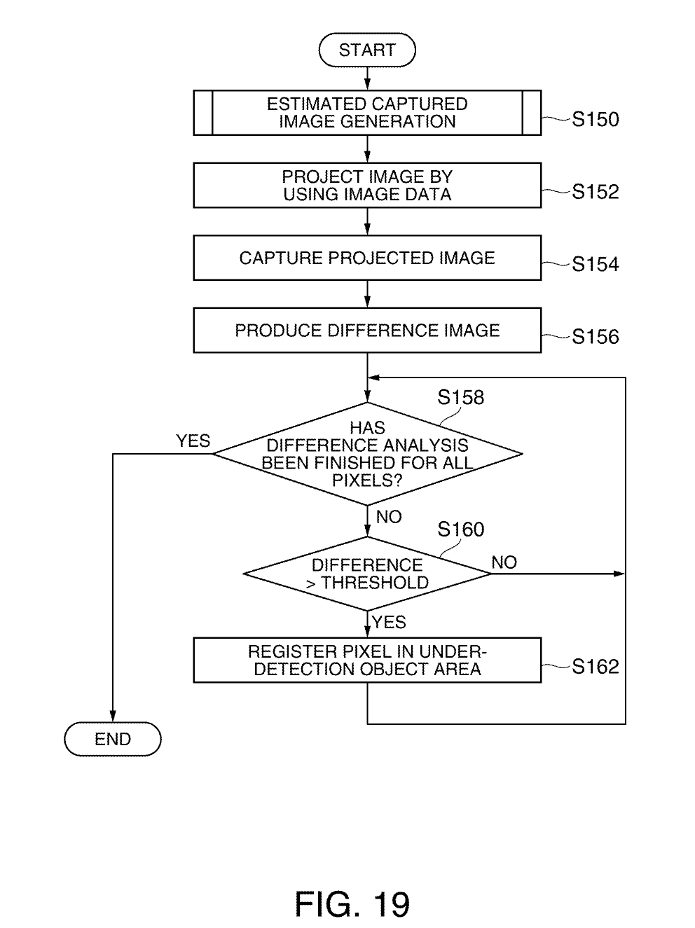

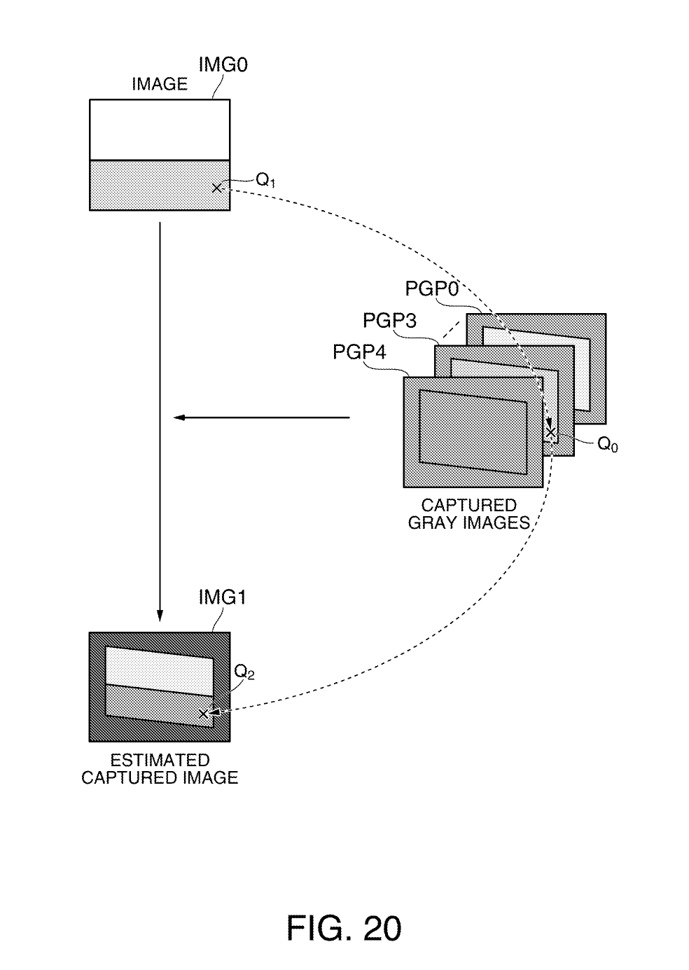

FIG. 19 is a flowchart showing an example of under-detection object extraction in the second embodiment, and FIG. 20 describes how an estimated captured image is generated in the under-detection object extraction. FIG. 20 diagrammatically shows the estimated captured image generation for a single color component among a plurality of color components that form a single pixel.

When the under-detection object extraction starts as in the first embodiment, the under-detection object area extracting section 60a instructs the estimated captured image generating section 70a to perform estimated captured image generation (step S150). In the estimated captured image generation, image data on an estimated captured image is generated by referring to each pixel value of the captured gray images saved in step S138 and converting the image data to be actually projected by the projector 100. The under-detection object area extracting section 60a saves the estimated captured image generated in step S150 in the estimated captured image saving section 62.

In step S150, the estimated captured image generating section 70a generates an estimated captured image, as in the first embodiment. That is, the estimated captured image generating section 70a first uses the positions of the four corners in the captured image acquired in step S130 to perform known shape correction on the image represented by the original image data. The estimated captured image generating section 70a then generates an estimated captured image, as in the first embodiment, from the image having undergone the shape correction. More specifically, when an image IMG0 represented by the original image data is used, for each pixel thereof, a captured gray image whose pixel value (R, G, or B value) is close to that in the position of that pixel is determined, as shown in FIG. 20. The estimated captured image generating section 70a then uses the pixel value in the pixel position in the captured gray image that corresponds to the pixel position described above to determine the pixel value in the pixel position in an estimated captured image IMG1 that corresponds to the pixel position described above. In this process, the estimated captured image generating section 70a uses the pixel value in a pixel position in a captured gray image PGPk or the pixel values in a pixel position in the captured gray images PGPk and PGP(k+1) to determine the pixel value in the pixel position in the estimated captured image IMG1. The estimated captured image generating section 70a repeats the processes described above on a color component basis for all the pixels to generate the estimated captured image IMG1. The estimated captured image generating section 70a can thus allow the shape of the estimated captured image to coincide with the shape of the projected image in the captured image.

The under-detection object area extracting section 60a then instructs the image data output section 64 to output the original image data to be actually projected by the projector 100 to the projector 100, which then projects an image based on the image data on the projection surface S (step S152). The original image data is image data used to generate the estimated captured image in the estimated captured image generation in step S150.

The under-detection object area extracting section 60a then controls the camera 20 to capture the image projected in step S152 and acquires image capturing information on the captured image (step S154). The captured image acquired at this point has an under-detection object area therein because the image projected by the projector 100 is blocked by the under-detection object 200.

The under-detection object area extracting section 60a then refers to the estimated captured image saved in the estimated captured image saving section 62 and the captured image acquired in step S154 and calculates for each pixel the difference between the corresponding pixel values to produce a difference image (step S156).

The under-detection object area extracting section 60a then analyzes the difference for each pixel of the difference image. When the difference analysis is finished for all the pixels of the difference image (Y in step S158), the under-detection object area extracting section 60a terminates the series of processes (END), whereas when the difference analysis is not finished for all the pixels (N in step S158), the under-detection object area extracting section 60a judges whether or not the difference is greater than a threshold (step S160).

When it is judged in step S160 that the difference is greater than the threshold (Y in step S160), the under-detection object area extracting section 60a registers the pixel under judgment as a pixel of the under-detection object area, which is the portion blocked by the under-detection object 200 (step S162), and the control returns to step S158. In step S162, the position of the pixel may be registered, or the pixel of the difference image may be converted into a pixel having a predetermined color so that the pixel becomes visible. On the other hand, when it is judged in step S160 that the difference is not greater than the threshold (N in step S160), the control returns to step S158 and the under-detection object area extracting section 60a continues the relevant processes.

The image processor 50a can extract the area of the under-detection object 200 by carrying out the processes described above, as in the first embodiment. In the second embodiment as well, the image processing apparatus may include a CPU, a ROM, and a RAM, and the CPU, after reading a program stored in the ROM or the RAM, may carry out software processes corresponding to the program to achieve the processes in the second embodiment described above. In this case, the program corresponding to the process flowchart described above is stored in the ROM or the RAM.

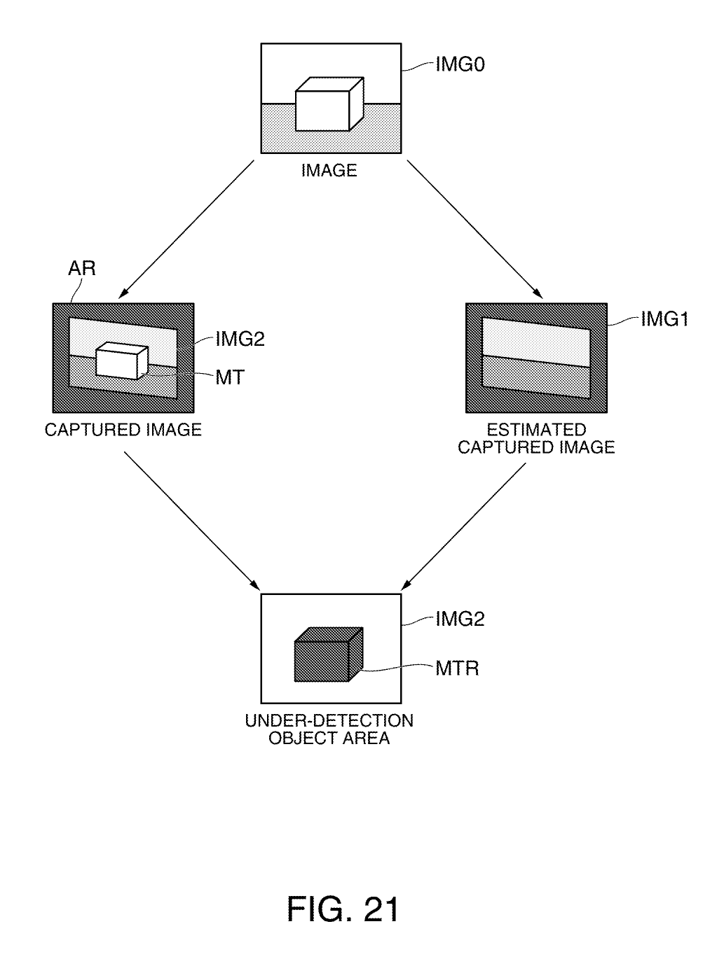

FIG. 21 describes how the image processor 50a operates. The image processor 50a uses the image data on the image IMG0 projected by the projector 100 to produce the estimated captured image IMG1 as described above. In this process, the positions of the four corners of an image in a projection area AR (projection surface IG1) extracted in advance are used to produce the estimated captured image IMG1 having undergone shape correction.

On the other hand, the image processor 50 instructs the projector 100 to project an image (displayed image) IMG2 in the projection area AR (projection surface IG1) of the projection surface S based on the image data on the image IMG0. The image processor 50 instructs the camera 20 to capture the image IMG2 in the projection area AR with the under-detection object 200 placed on the projection surface S and acquires image capturing information on the thus captured image. The captured image contains a captured image MT formed of the captured under-detection object 200.

The image processor 50a calculates the difference between the image IMG2 in the captured image and the estimated captured image IMG1 for each pixel and extracts an under-detection object area MTR of the under-detection object 200 in the image IMG2 based on the difference.

### Third Embodiment

The first and second embodiments have been described with reference to the case where the projector 100, which is an image projection apparatus as an image display apparatus, is used and when an image projected by the projector 100 is blocked by the under-detection object 200, the area of the under-detection object 200 in the projected image is extracted from the projected image, but the invention is not limited thereto.

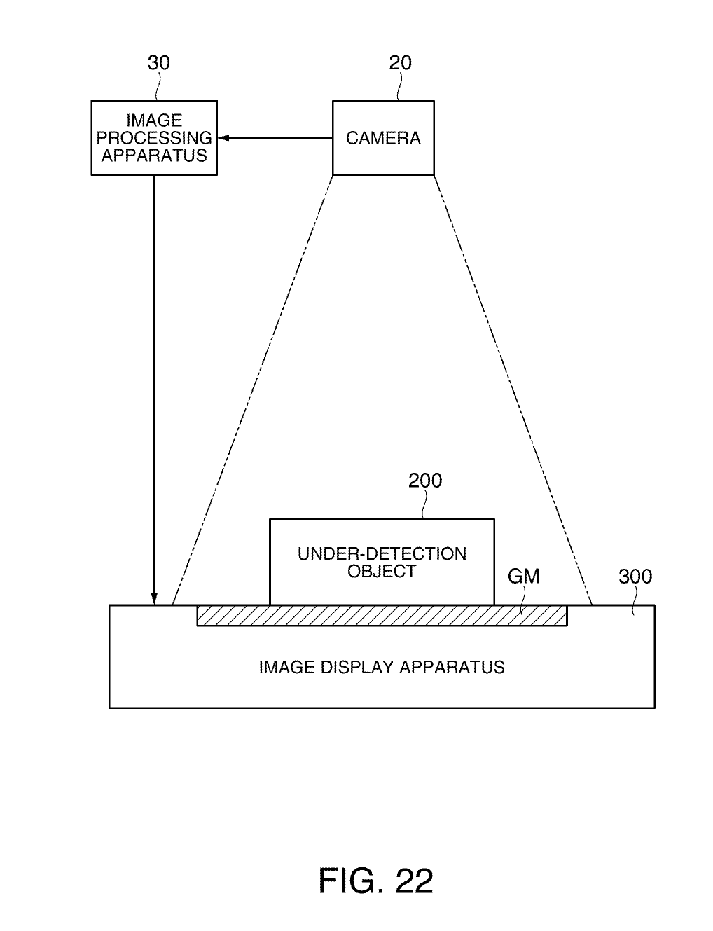

FIG. 22 is a diagram showing an example of the configuration of an image display system in a third embodiment. An image display system 10a in the third embodiment includes a camera 20 as an imager, an image processing apparatus 30, and an image display apparatus 300 having a screen GM. The image display apparatus 300 displays an image on the screen GM (display screen in a broad sense) based on image data from the image processing apparatus 30. Examples of the image display apparatus may include a liquid crystal apparatus, an organic EL display apparatus, and a CRT. The image processing apparatus 30 may be the image processing apparatus in the first or second embodiment.

When an under-detection object 200 present between the camera 20 and the screen GM blocks a displayed image, the image processing apparatus 30 uses image capturing information obtained when the camera 20 captures the displayed image to detect the area of the under-detection object 200 in the displayed image. More specifically, the image processing apparatus 30 uses the image data corresponding to the image displayed on the screen GM to produce an estimated captured image, which is an estimated state produced if the camera 20 captures the displayed image, and detects the area of the under-detection object 200 based on the difference between the estimated captured image and a captured image obtained by using the camera 20 to capture the displayed image blocked by the under-detection object 200.

It is therefore unnecessary to provide a dedicated camera, and the area of the under-detection object 200 can be detected at a low cost. Further, being detected based on the difference between an estimated captured image and a captured image, the area of the under-detection object 200 can be precisely detected without being affected by noise resulting from external light, the state of the screen GM, and other factors even when the image displayed on the screen GM of the image display apparatus 300 suffers from color unevenness due to the noise.

The image processing apparatus, the image display system, and the image processing method according to embodiments of the invention have been described above. The invention is, however, not limited to any of the embodiments described above but can be implemented in a variety of aspects to the extent that they do not depart from the substance of the invention. For example, the following variations can be provided.

1. The above embodiments have been described with reference to an image projection apparatus or an image display apparatus, but the invention is not necessarily implemented this way. The invention is, of course, applicable to a whole range of apparatus that displays an image based on image data.

2. The first and second embodiments have been described with reference to an apparatus using light valves each of which uses a transmissive liquid crystal panel as a light modulator, but the invention is not necessarily implemented this way. The light modulator may, for example, be a digital mirror device (DMD), a device based on LCOS (Liquid Crystal On Silicon), any other suitable component. Further, in the first and second embodiments, the light modulator may be a light valve using what is called a three-panel transmissive liquid crystal panel or a light valve using a single-panel liquid crystal panel, a two-panel transmissive liquid crystal panel, or a transmissive liquid crystal panel using four or more panels.

The entire disclosure of Japanese Patent Application No. 2010-4172, filed Jan. 12, 2010 is expressly incorporated by reference herein.

What is claimed is:

1. An image processing apparatus that detects an under-detection object disposed between a display screen and a camera and outputs information on the under-detection object having been detected, the image processing apparatus comprising:
an under-detection object detecting section that detects an under-detection object area, which is a portion blocked by the under-detection object, in an image displayed on the display screen based on image data, the detection being performed based on a captured image obtained by using the camera to capture the displayed image blocked by the under-detection object; and
an application processor that extracts an under-detection object captured image contained in the under-detection object area from the captured image, acquires shape data representing an image of the under-detection object from a database that stores the shape data and information data representing information on the under-detection object that corresponds to the shape data, the information data being related to the shape data, checks the under-detection object captured image against the shape data, acquires the information data related to the shape data that matches the under-detection object captured image from the database, and outputs the information data.

2. The image processing apparatus according to claim 1, further comprising:
an estimated captured image generating section that generates an estimated captured image from the image data based on image capturing information obtained by capturing a model image displayed on the display screen with the camera without being blocked by the under-detection object,
wherein the under-detection object detecting section detects the under-detection object area, which is a portion blocked by the under-detection object, in the displayed image based on the difference between the captured image and the estimated captured image.

3. The image processing apparatus according to claim 2,
wherein the model image is formed of multiple types of gray image, and
the estimated captured image generating section uses multiple types of captured gray image obtained by using the camera to capture the multiple types of gray image displayed on the display screen to generate the estimated captured image having estimated pixel values of the pixels of the displayed image corresponding to the image data.

4. The image processing apparatus according to claim 2, further comprising:
an image region extracting section that extracts the displayed image region from the captured image and allows the shape of the displayed image in the captured image to coincide with the shape of the estimated captured image,
wherein the under-detection object detecting section detects the under-detection object area based on a result of comparison for each pixel between the displayed image extracted by the image region extracting section and the estimated captured image.

5. The image processing apparatus according to claim 2,
wherein the estimated captured image generating section allows the shape of the estimated captured image to coincide with the shape of the displayed image in the captured image, and
the under-detection object detecting section detects the under-detection object area based on a result of comparison for each pixel between the displayed image in the captured image and the estimated captured image.

6. The image processing apparatus according to claim 4,
wherein a predetermined image for initialization displayed on the display screen is captured by the camera, and the shape of the estimated captured image or the displayed image is allowed to coincide with the shape of the other based on the positions of four corners of the image for initialization in the captured image.

7. The image processing apparatus according to claim 1,
wherein an image projection apparatus is provided as an image display apparatus, and the displayed image is an image projected by the image projection apparatus based on the image data.

8. The image processing apparatus according to claim 1,
wherein the application processor rotates one of the under-detection object captured image and an image represented by the shape data by a predetermined angle after the size of the under-detection object area is allowed to coincide with the size of the under-detection object represented by the shape data to determine a check value representing the correlation between the under-detection object captured image and the image represented by the shape data, repeats the check value determination process multiple times with a different rotation angle, and compares a check value showing the highest correlation in the multiple check value determination processes with a predetermined threshold to judge whether or not the under-detection object captured image coincides with the image represented by the shape data.

9. An image display system comprising:
the image processing apparatus according to claim 1;
the camera that captures an image displayed on the display screen; and
an image display apparatus that displays not only an image based on image data on the model image or the displayed image but also an image bearing the information data outputted from the image processing apparatus.

10. An image processing method for detecting an under-detection object disposed between a display screen and a camera and outputting information on the under-detection object having been detected, the image processing method comprising:
an image display step of displaying an image on the display screen based on image data;
a displayed image capturing step of capturing the image displayed on the display screen in the image display step by using the camera with the displayed image being blocked by the under-detection object;
an under-detection object detecting step of detecting an under-detection object area, which is a portion blocked by the under-detection object, in the displayed image based on the image captured in the displayed image capturing step; and
an application processing step of extracting an under-detection object captured image contained in the under-detection object area from the captured image, acquiring shape data representing an image of the under-detection object from a database that stores the shape data and information data representing information on the under-detection object that corresponds to the shape data, the information data being related to the shape data, checking the under-detection object captured image against the shape data, acquiring the information data related to the shape data that matches the under-detection object captured image from the database, and outputting the information data.
